(19) United States
(12) Patent Application Publication
(10) Pub. No.: US 2002/0052199 A1
(43) Pub. Date: May 2, 2002

(54) Call center management for wireless access network

(76) Inventors: Mukesh Sundaram, San Jose, CA (US); Prem Uppaluru, Cupertino, CA (US)

Correspondence Address: Daniel E. Ovanezian, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/016,221

(22) Filed: Oct. 30, 2001

Related U.S. Application Data
(60) Provisional application No. 60/244,722, filed on Oct. 30, 2000.

(51) Int. Cl. H04Q 7/20

(52) U.S. Cl. 455/428; 455/434

(57) ABSTRACT

A call center system that transmits call availability from a call center to a remote user of a wireless network via a virtual private network to reduce communication costs and to improve operational efficiency. The call center system includes a set of point-of-presence call center gateways distributed at points of presence that are close to the point of the remote user. The point-of-presence call center gateways are connected by the virtual private network to call center gateways at business locations where call centers reside.

### CROSS REFERENCES TO RELATED APPLICATIONS

This application claims priority to U.S. provisional patent application Ser. No. 60/244,722, titled, “Call Center Management For Wireless Access Network” filed on Oct. 30, 2000.

### FIELD OF THE INVENTION

The present invention relates to the field of telecommunications, and more particularly to management of calls for a wireless access network.

### BACKGROUND

Wireless systems are communication systems in which waves (e.g., electromagnetic and acoustic) carry a signal through atmospheric space rather than exclusively along a wire. Wireless systems may include, for examples, the Global Positioning System (GPS), wireless telephony systems, and local area networks.

FIG. 1 illustrates a wireless telephony system. A wireless telephony system may utilize various types of equipment, protocols, and signal frequencies for transmission. Most wireless systems (e.g., cellular and personal communication services) operate with a type of short-wave analog or digital transmission of data in which a user has a wireless connection from a wireless telephone to a relatively nearby transmitter. The geographic area covered by a transmitter is referred to as a cell. The cell provided by a transmitter may be many miles in diameter depending on the terrain and transmission power of the transmitter. Several transmitters that are located locally to each other constitute a transmitter system. As the user moves from one cell area of coverage to another, the transmission of data is passed on to another transmitter system.

When a user subscribes to a wireless telephone service, the user is assigned to a local cell system. When the user travels outside the range of their cell system, the transmission may be transferred to a different cell system. When the user places a call, voice data may be transmitted to another wireless phone or to a landline telephone in a business call center. To complete a call to a landline telephone, the cell sites in a cell system are connect to a Mobile Telephone Switching Office (MTSO). The MTSO is connected to the Public Switched Telephone Network (PSTN) which, in turn, is connected to landline telephones.

A wireless telephony system may provide services in addition to the transmission of voice data between users. Wireless telephony systems may provide push services such as text messaging and paging, pull services such as voice mail, and interactive data services. Although these non-voice data services may require less bandwidth and quality for the signal transmission, the user may be charged a rate based on the time of use regardless of the type of data being transmitted. As such, a user may incur substantial charges when using such a system for non-voice data, particularly when transmitting outside a transmission system. In addition, a customer service representative may have to be used to provide the remote user with access to some or all the services.

FIG. 2 illustrates one prior wireless telephony system that utilizes interactive services. The wireless telephony system may be connected to an Internet Protocol (IP) network through a gateway. The IP network transmits data in the form of packets that include an address specifying the destination for which the data is intended. The network uses a network layer that defines an official packet format and protocol called the Internet Protocol. The wireless network uses a wireless application protocol (WAP) to enable wireless phone users to access live and interactive information services and applications from screens of the wireless phones. Such services may include email, unified messaging, news, and electronic commerce transactions. WAP defines an eXtensive Markup Language (WML) syntax called Wireless Markup Language (WML). WML content may be accessed over the IP network using standard HTTP 1.1 requests.

The IP network contains a collection of clients (e.g., a business call center and wireless phone users) that are interconnected by transmission lines to enable the transfer of data between them. A business call center may include system applications to answer, service, queue and route calls. The gateway between the IP network and the wireless network enables applications to notify users when information arrives at their wireless phones. Such notification may include audible alerts, visible alerts, and links for taking immediate action. For example, a voice message alert may indicate that a voice message is available to the user. A link may then be provided to the user that, when activated, automatically dials a phone number to establish a call. The system of FIG. 2 may suffer from the same problem as the system of FIG. 1, in that a user may incur substantial charges when transmitting and receiving data, in particular, from outside a transmission system.

### SUMMARY OF THE INVENTION

The present invention pertains to a method of call management. In one embodiment, the method may include directing notification of a call from a call center to a remote user on a wireless network. The notification may be directed along a first wireless path. The method may also include responding to the notification by the remote user with the response directed along the first wireless path from the remote user to the call center. The method may also include establishing the call between the call center and the remote user along a second wireless path.

Additional features and advantages of the present invention will be apparent from the accompanying drawings and from the detailed description that follows.

### BRIEF DESCRIPTION OF THE DRAWINGS

The present invention is illustrated by way of example, and not by way of limitation, in the figures of the accompanying drawings and in which:

FIG. 1 illustrates a wireless telephony system.

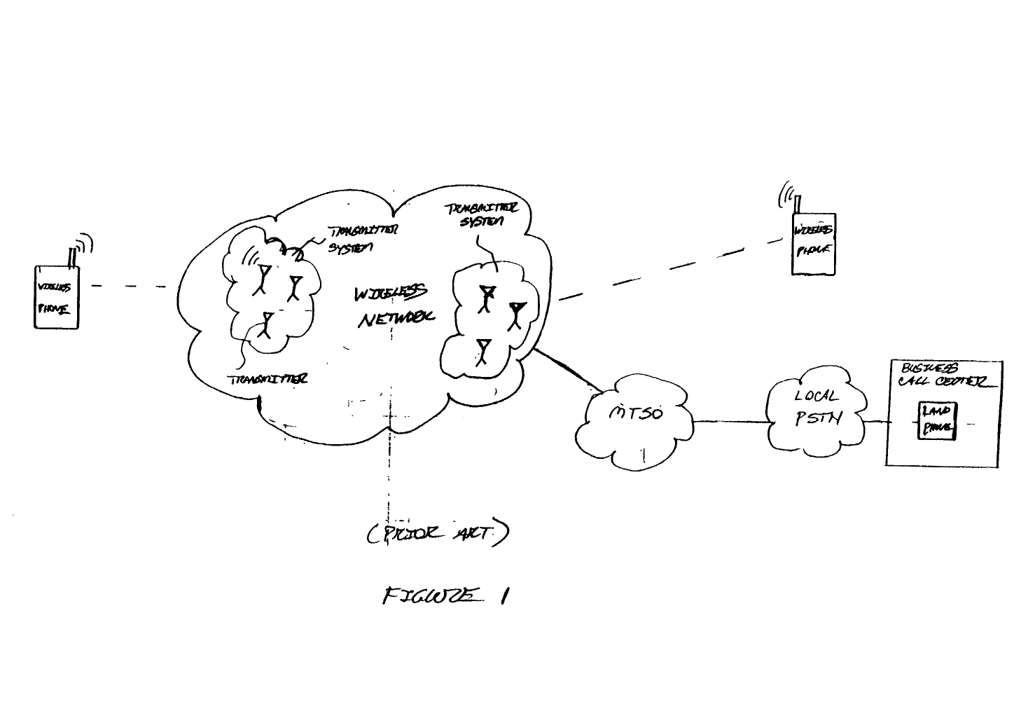

FIG. 2 illustrates a wireless telephony system that utilizes interactive services.

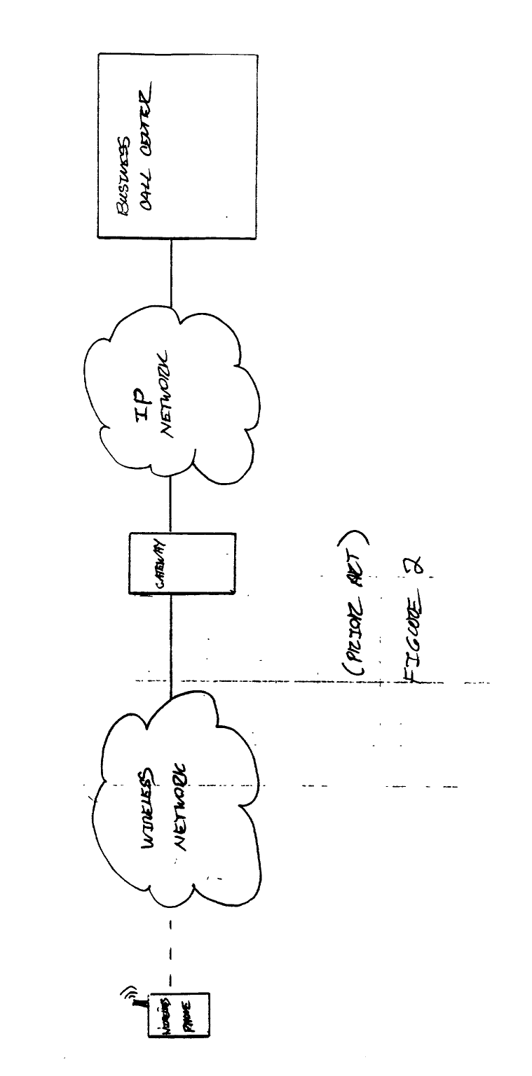

FIG. 3 illustrates one embodiment of components of a call center system having a wireless network.

FIG. 4 illustrates one embodiment of a configuration of a call center system having a wireless network.

FIG. 5 illustrates an alternative embodiment of a call center system having a wireless network.

FIG. 6 is a flowchart illustrating one embodiment of a method of call management in a call center system.

### DETAILED DESCRIPTION

In the following description, numerous specific details are set forth such as examples of specific components, protocols, networks, methods, etc. in order to provide a thorough understanding of the present invention. It will be apparent, however, to one skilled in the art that these specific details need not be employed to practice the present invention. In other instances, well-known components or methods have not been described in detail in order to avoid unnecessarily obscuring the present invention. Although the present invention is described by way of various embodiments that include specific structures and methods, embodiments that include alternative structures and methods may be employed without departing from the principles of the invention described herein.

The method and apparatus described herein provides for the transmission of call availability data and call data from a call center to a remote user of a wireless network via different wired networks. Such a method and apparatus may operate to reduce communication costs and improve operational efficiency. The call data may be, for examples, voice data from an active voice call and voice data retrieved from voice mail. The call availability data may be various types of data that identify to the user the availability of call data, for examples, an audible signal and a text message.

In one embodiment, the call availability data may be transmitted along a private call center network while the call data may be transmitted along a different network suitable for voice data transmission. The call center network may be coupled to a point-of-presence (POP) call center gateway that is located locally to the remote user. The POP call center gateway may be capable of providing interactive services and initiating the establishment of a call between the call center and the remote user.

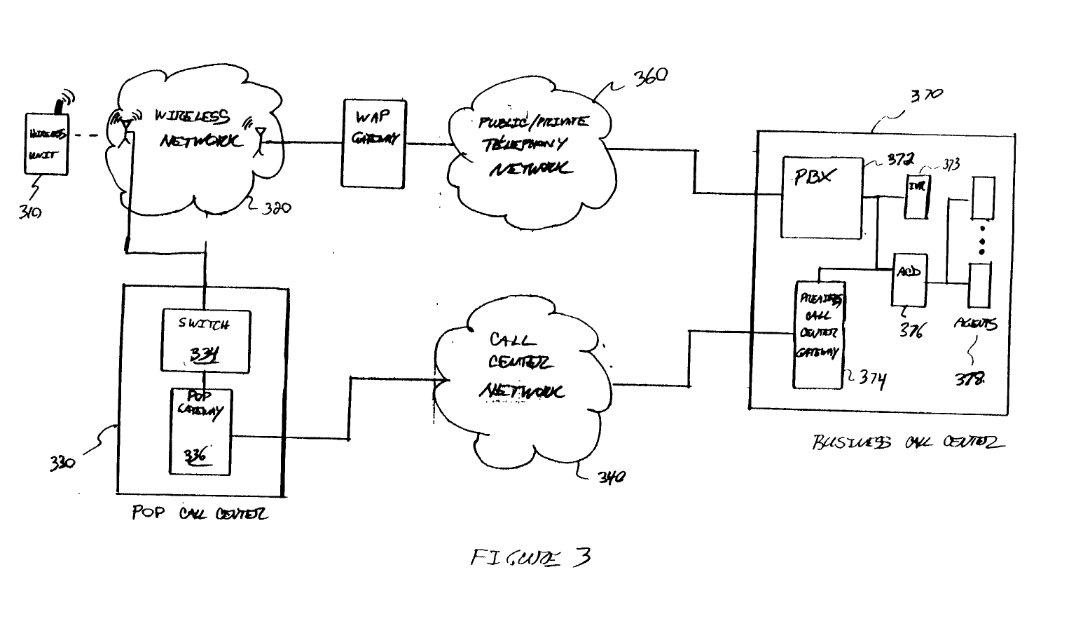

FIG. 3 illustrates one embodiment of components of a call center system having a wireless network. In one embodiment, a remote user operating a wireless network access device (e.g., WAP unit 310) may be notified of a call from a business call center 370 via call center network 340 and POP call center 330. The POP call center system is capable of locally providing notification of the availability of call data to remote users. The POP call center is also capable of providing notification without the need of a customer service representative. This may, thereby, save a remote user communications costs and increase the operating efficiency of the system.

Business call center 370 may integrate multiple systems components into a complete business solution to answer, service, queue and route customer calls. These business call center 370 components may provide for various enterprise applications, for example, voice mail. These components may include, for examples, a Private Branch Exchange (PBX) 372, an Automatic Call Distributor (ACD) 376 and an Interactive Voice Response (IVR) System 373. In one embodiment, the business call center 370 may also include a customer service or help desk applications for one or more call center agents 378.

In one embodiment, premises call center gateway 374 may further include a premises call manager, a premises voice response server and premises network manager software module hosted on an industry standard computer telephony server that may be similar to a server hosting the POP call center gateway 336. In an alternative embodiment, a premises call center gateway may include an IP telephony gateway server and a separate applications server connected over a high-speed local area network. In such a configuration, the applications server hosts the premises call manager, premises voice response server and premises network manager software modules which interact with the IP telephony gateway for voice communications and signaling.

The POP call center system handles call availability data at or near their point of call data destination (i.e., the presence of the remote user). The POP call center system extends the conventional premises and network based call center systems to a fully distributed call center system with multiple points of presence. The POP call center system consists of one or more POP call center gateway servers 336 distributed at one or more points of presence 330 close to the destination points of call data.

One of the POP call centers may be selected dynamically at the time of handling of outgoing call data from a business call center 370 to a wireless unit 310. The POP call center gateway servers 336 are connected by one or more call center networks 340 to premises call center gateway servers 374 at one or more POP-enabled business call centers 370. POP call center gateway server 336 is connected to a switch 334 enabling it to transmit and receive call notification data on wireless network 320.

In one embodiment, POP gateway 336 may provide automated service with interactive voice response applications. If a call is queued, this gateway further requests a corresponding premises call center gateway 374 to originate a proxy call at the call center ACD 376 on its behalf and monitor the progress of the queued call. When the premises call center gateway 374 is notified by the POP call center gateway 336 that a call connection is to be established, the premises call center gateway 374 may route the locally queued call to the public/private telephony network 360 for transmission to wireless unit 310 via wireless network 320.

In one embodiment, POP call center gateway 336 may further include a POP call manager, a POP voice response client, and a POP network manager software modules hosted on an industry-standard computer telephony server. A computer telephony server consists of an industry standard server computer such as an Intel PC server or Sun Microsystems server enhanced with telephony and voice processing capabilities and running an industry standard applications server operating system such as Microsoft Windows NT or Sun Microsystems Solaris. In an alternative preferred embodiment, POP call center gateway 336 can comprise an IP telephony gateway server and a separate applications server connected over a high-speed local area network. An IP telephony gateway is capable of translating traditional circuit switched voice communications to packet switched communications and transporting voice over long distance using IP networks. In such a configuration, the applications server hosts the POP call manager, POP voice response client and POP network manager modules which interact with the IP telephony gateway for voice communications and signaling.

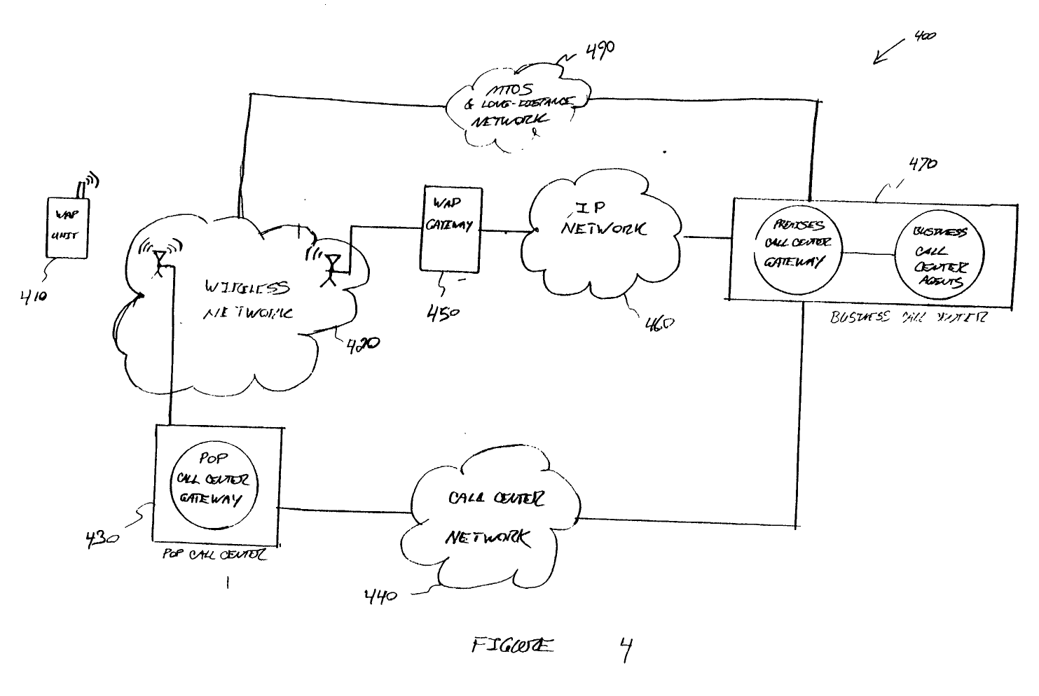

FIG. 4 illustrates one embodiment of a configuration of a call center system having a wireless network. In one embodiment, the call center system 400 includes a virtual private network 440 connecting POP call center 430 to one or more premises call center gateways all of which belong to a single business call center 470. Virtual private network 440 may offer industry standard connection and transport protocols such as ATM, Frame Relay or Internet Protocol (IP) for secure and private data communications between connecting entities with optional quality of service guarantees. Call center 470 may also be connected to wireless network 420 via a public/private telephony network, for examples, IP network 460 and long distance network 490. In an alternative embodiment, call center 470 and wireless network may 420 be connected via other types of telephony networks, for example, MTOS & long distance telephony network 490.

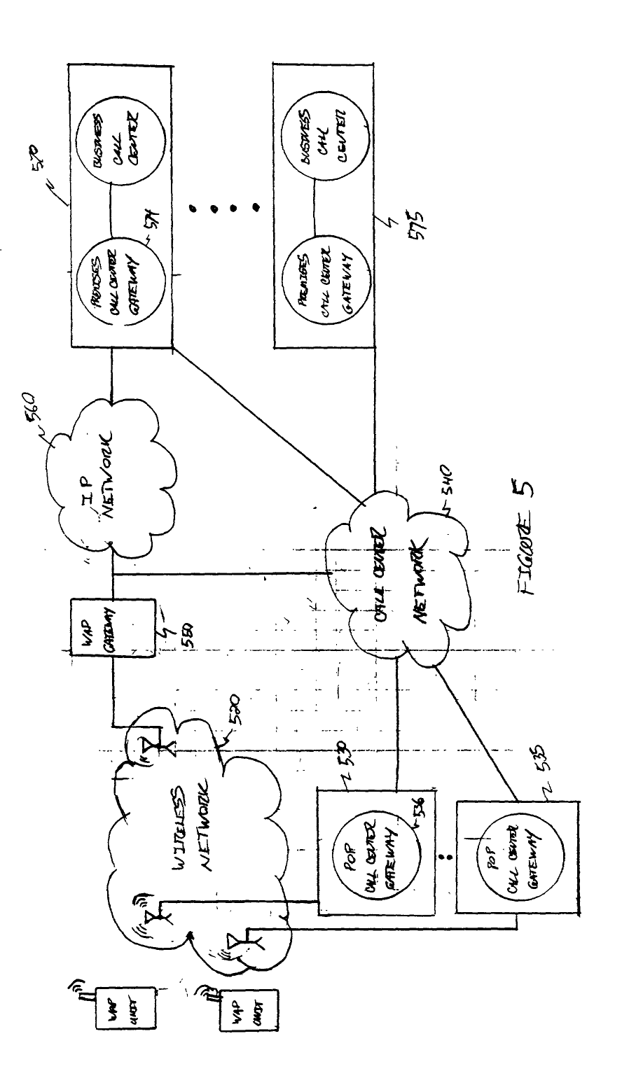

FIG. 5 illustrates an alternative embodiment of a call center system having a wireless network. Each POP call center gateway (e.g., gateways 530 and 535) can be part of multiple such call center networks one for each business call center that it serves (e.g., business call centers 570 and 575). POP call center gateways (e.g., gateway 536) use a call center network 540 to connect to corresponding premises call center gateways (e.g., gateway 574) and access appropriate call data applications and information as well as request call connections to wireless units through IP network 560.

For each participating business call center network, the call center system assigns a unique universally accessible toll-free number. This number may be a previously existing 800/888 toll-free access number of a participating business call center. Depending on the geographic areas in which it wishes to receive POP call center service, the participating business call center chooses one or more POP call centers to be connected to its call center network. The POP call center system then assigns a distinct direct dial (DD) number for each POP call center connected to the business call center network. This DD number, also referred to as the POP call center called party number, uniquely identifies at each POP call center the specific business call center to which a call is targeted. The POP call center gateway uses this called party number to identify the network address of the corresponding premises call center gateway.

In an alternative embodiment, call center network 540 may optionally support voice communications over ATM, Frame Relay or IP protocols. In such a case, the POP call center gateways can use the call center network as an alternative voice communications network by bridging calls across a premises call center gateway (e.g., gateway 574) to the wireless network gateway 550.

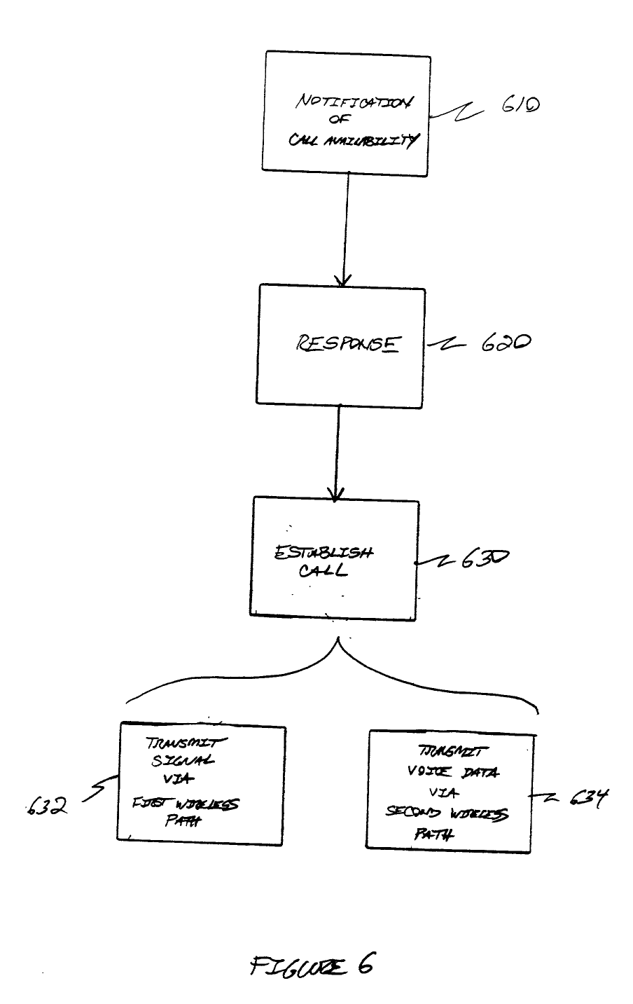

FIG. 6 is a flowchart illustrating one embodiment of a method of call management in a call center system. In one embodiment, a remote user of a call center system receives notification of the availability of call data, step 610. The call availability data may be various types of data that identify to the user the availability of call data, for examples: a phone number that may connect the user to another user; an audible signal or text or pre-recorded voice message that identifies the availability of voice mail. The notification may be transmitted along a first wireless data path. In one embodiment, the first wireless data path may be call center network 440 of FIG. 4.

Upon receiving notification of the call availability data, the remote user may respond to the notification with a response signal transmitted along the first wireless path, step 620. In one embodiment, the remote user may respond immediately after receiving the notification. In an alternative embodiment, the remote user may elect to respond at later time to the notification.

When the call center receives the response signal, the call center may establish a call connection between the call center and the remote user, step 630. In one embodiment, the call connection is an active voice call with another user. In an alternative embodiment, the call connection may be other types of voice data, for example, a voice message that was left in the remote user's voicemail box. The response signal may be transmitted along the first wireless path from the remote user to the call center having the call data, step 632, and the call data may be transmitted along a second wireless path from the call center to the remote user, step 634. In one embodiment, the second wireless data path may be a telephony network different from the first wireless data path, for example, IP network 460 of FIG. 4.

The steps shown in FIG. 6 may provide the remote user with call data using local notification of the availability of the call data and without the use of a customer service representative, thereby saving on communications costs and increasing operating efficiency. For example, a call center may have a voice message intended for a remote user. The call center may transmit a signal (e.g., a page and a text message) through the call center network to a POP call center. This allows the remote user to interact with the call center in deciding whether to receive the call data via the call center network without the use of a customer service representative. In addition, because the POP call center is located locally to the remote user, the remote user may interact with the call center without accumulating the expense of a long distance toll charge.

If the remote user decides not to be connected with the call center to receive the voice message at that time, then the voice message may be logged in the call center for retrieval at a later time. If the remote user decides to receive the voice message at the time of notification, then the remote user may perform a single action (e.g., pressing a button on the wireless unit, enter a voice command) to receive the voice message over a long distance network.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method of a call management in a system having a wireless network, comprising:
receiving a notification of call data, the notification received through a first wireless path;
selecting receipt of the call data; and
establishing a call connection based on the selection, the call connection established through a second wireless path, the second wireless path different than the first wireless path.

2. The method of claim 1, wherein selecting comprises selecting receipt of the call connection data at a time when the notification is received.

3. The method of claim 1, wherein selecting the call connection data comprises retrieving the call data from a previously stored location at a time after the notification is received.

4. The method of claim 1, wherein the call connection is established in response to only a single action being performed.

5. The method of claim 1, wherein establishing the call connection comprises:
transmitting a signal through the first wireless path; and
transmitting the call data through the second wireless path.

6. The method of claim 1, wherein the first wireless path includes an Internet Protocol network.

7. The method of claim 1, wherein the second wireless path includes a call center network.

8. The method of claim 1, wherein the first wireless path includes a long distance telephony network.

9. A method of call management, comprising:
directing notification of a call from a call center to a remote user on a wireless network, the notification directed along a first wireless path;
responding to the notification by the remote user, the response directed along the first wireless path from the remote user to the call center; and
establishing the call between the call center and the remote user along a second wireless path.

10. The method of claim 9, wherein the first wireless path includes an long distance network.

11. The method of claim 10, wherein the second wireless path comprises a call center network.

12. The method of claim 11, wherein the second wireless path comprises a point-of-presence call center gateway.

13. The method of claim 12, wherein establishing the call comprises:
transmitting a signal from the remote user to the call center through the first wireless path; and
transmitting voice data from the call center to the remote user through the second wireless path.

14. The method of claim 13, wherein the first wireless path includes an Internet Protocol network.

15. A wireless telephony system, comprising:
means for receiving a notification of call connection data, the notification received through a first wireless path;
means for selecting the call connection data; and
means for establishing a call connection based on the call connection data, the call connection established through a second wireless path, the second wireless path different than the first wireless path.

16. The method of claim 15, wherein means for selecting the call connection data comprises selecting the call connection data at a time when the call connection data is received.

17. The method of claim 15, wherein means for selecting the call connection data comprises retrieving the call connection data from a previously stored location.

18. The method of claim 15, wherein the call connection is established in response to only a single action being performed.

19. A method of call handling, comprising:
directing notification of a call from a call center to a remote user through a first network;
receiving a request to transmit the call to the remote user, the request received by the call center; and
responding to the request by directing the call to the remote user via a second network.

20. The method of claim 19, wherein the first network is long distance telephone network and the second network is a call center network.

21. The method of claim 19, wherein the call is directed without the intervention of a person.

22. A system, comprising:
a first wired network to carry call data;
a second wired network to carry call availability data;
a wireless network coupled to the first and the second wired networks; and
a call center coupled to the first and the second wired networks, the call center to transmit the call data and the call availability data.

23. The system of claim 22, further comprising:
a wireless unit coupled to the wireless network to receive the call data and the call availability data;
a first gateway coupled between the wireless network and the first wired network; and
a second gateway coupled between the wireless network and the second wired network.

24. The system of claim 23, wherein the first wired network is a long distance telephone network and wherein the second wired network is a private call center network.
